(19) United States
(12) Patent Application Publication
(10) Pub. No.: US 2014/0296463 A1
(43) Pub. Date: Oct. 2, 2014

(54) POLYMERS DERIVED FROM ITACONIC ACID

(71) Applicant: LUBRIZOL ADVANCED MATERIALS, INC., Wickliffe, OH (US)

(72) Inventors: John Ta-Yuan Lai, Broadview Heights, OH (US); Gary A. Anderle, North Olmsted, OH (US); Ti Chou, Bay Village, OH (US)

(73) Assignee: Lubrizol Advanced Materials, Inc., Wickliffe, OH (US)

(21) Appl. No.: 13/851,226

(22) Filed: Mar. 27, 2013

(51) Int. Cl. C08F 222/02; C08F 122/02

(52) U.S. Cl. CPC C08F 222/02; C08F 122/02
USPC 526/312; 526/318.2

(57) ABSTRACT

This invention relates to polymers containing structural units derived from itaconic acid which are useful, including uses as binders for fiberglass.

### TECHNICAL FIELD

This invention relates to polymers derived from itaconic acid. More particularly, this invention relates to polymers comprising structural units derived from itaconic acid which are useful.

### BACKGROUND

Fibrous glass insulation products generally comprise matted glass fibers bonded together by a cured thermoset polymeric material. Molten streams of glass are drawn into fibers of random lengths and blown into a forming chamber where they are randomly deposited as a mat onto a traveling conveyor. The fibers, while in transit in the forming chamber and while still hot from the drawing operation, are sprayed with an aqueous binder. Formaldehyde-based binders are typically used. The residual heat from the glass fibers and the flow of air through the fibrous mat during the forming operation are generally sufficient to volatilize the majority to all of the water from the binder, thereby leaving the remaining components of the binder on the fibers as a viscous or semi-viscous high-solids liquid. The coated fibrous mat is then transferred out of the forming chamber to a curing oven where heated air, for example, is blown through the mat to cure the binder and rigidly bond the glass fibers together.

Binders useful in fiberglass insulation products generally require a low viscosity in the uncured state, yet characteristics so as to form a rigid thermoset polymeric mat for the glass fibers when cured. A low binder viscosity, in the uncured state, is required to allow the mat to be sized correctly. Also, various binders tend to be tacky or sticky and hence they lead to accumulation of fibers on the forming chamber walls. This accumulated fiber may later fall onto the mat causing dense areas and product problems. A binder, which forms a rigid matrix when cured, is required so that a finished fiberglass thermal insulation product, when compressed for packaging and shipping, will recover to its specified vertical dimension when installed in a building.

Over the past several decades it has become necessary to minimize the emission of volatile organic compounds (VOCs) as a result of environmental regulations. This has led to extensive investigations into reducing emissions from formaldehyde-based binders, as well as searching for replacement binders that are formaldehyde-free. One such replacement binder employs polymers derived from acrylic acid.

### SUMMARY

There are problems with using acrylic binders. These include the fact that acrylic acid is generally not considered to be “green” (it is typically derived from petroleum and is therefore not renewable) and its polymerization is often difficult to control. The present invention provides a solution to these problems. With the present invention, polymers derived from itaconic acid are useful for a variety of applications including as binders for fiberglass products. Itaconic acid is “green” (it is derived from renewable resources) and it is non-toxic. Homopolymers of itaconic acid are biodegradable. Polymers derived from itaconic acid are easier and safer to handle than polymers of acrylic acid due to the fact that with polymers of itaconic acid no inhibitors are required.

This invention relates to a polymer comprising structural units derived from itaconic acid, or an anhydride or salt thereof, the polymer having a number average molecular weight of about 5000 or higher. When dissolved or dispersed in water at a concentration of about 50% by weight polymer, the resulting aqueous composition has a viscosity of about 750 centipoise or less. The polymer may comprise a homopolymer or a copolymer. The polymer may be grafted with one or more polyols. The polymer may be used as a binder for fiberglass. An advantage of using polymers derived from itaconic acid, or an anhydride or salt thereof, is that aqueous compositions (e.g., solutions or emulsions) containing the polymer that exhibit undesirable levels of color may have the color reduced or eliminated by treating the compositions with hydrogen peroxide.

### DETAILED DESCRIPTION

All ranges and ratio limits disclosed in the specification and claims may be combined in any manner. It is to be understood that unless specifically stated otherwise, references to “a,” “an,” and/or “the” may include one or more than one, and that reference to an item in the singular may also include the item in the plural. Co-monomer(s) refers to co-monomer or co-monomers in the alternative.

Itaconic acid is an organic compound which is non-toxic and may be derived from renewable resources. Homopolymers of itaconic acid are biodegradable. Itaconic acid may be obtained by the distillation of citric acid or by the fermentation of carbohydrates such as glucose using Aspergillus terreus. Itaconic acid may be referred to as methylenesuccinic acid or 2-methylidenebutanedioic acid. Itaconic acid may be represented by the formula C₅H₆O₄ or by the formula CH₂═C(COOH)CH₂COOH.

The polymer may be derived from itaconic acid, anhydride or one or more salts of itaconic acid. The salts may include sodium, potassium or ammonium salts of itaconic acid. The salts may include alkylated ammonium salts such as triethyl ammonium salt, and hydroxyl alkylated ammonium salts such as triethanol ammonium salt, and the like.

The polymer may be a homopolymer wherein the polymer backbone comprises structural units derived from itaconic acid, or an anhydride or salt thereof. The polymer may be a copolymer wherein the backbone of the polymer comprises structural units derived from itaconic acid, or an anhydride or salt thereof, as well as structural units derived from one or more co-monomers such as C₁-C₁₈ alkyl (meth)acrylates where the alkyl group may be a straight chain group or branched chain group. The alkyl group may be substituted with one or more hydroxyl groups, alkoxy groups, or a mixture thereof. The use of (meth) in a monomer name is meant to indicate the monomer with or without a methyl substituent. The monomers that may be used may include methyl acrylate, ethyl acrylate, butyl acrylate, 2-hydroxyethyl acrylate and its phosphate or polyphosphate esters, 2-hydroxyethyl methacrylate and its phosphate or polyphosphate esters, stearyl acrylate, polyethyleneglycol monomethylether acrylate, acrylamide, C₁-C₁₈ N-alkyl (meth)acrylamide, glycine acrylamide, sarcocine acrylamide, styrene and substituted styrene, vinyl esters such as vinyl acetate, acrylic acid and its sodium salt, 2-acrylamido-2-methylpropane sulfonic acid and its salts (AMPS™), acrylamido methanesulfonic acid and its sodium salt, maleic acid and its sodium salt, (meth)acrylonitrile, or a mixture of two or more thereof. The amount of co-monomer in the copolymer may be up to about 50% by weight of the copolymer, or from about 5 to about 50%, or from 5% to about 30%, or from about 10% to about 20% by weight of the copolymer. As the co-monomer(s) are generally more quickly incorporated into a polymer than itaconic acid, the co-monomer(s) concentration will generally be slightly higher in the polymer than in the co-monomer(s) concentration in the monomer fed to the polymerization. The amount of itaconic acid (the itaconic acid, itaconic anhydride, and the itaconic acid from the salt form of itaconic acid combined) is desirably at least 50, more desirably at least 70, and preferably at least 80% by weight of said polymer or copolymer derived from itaconic acid. Desirably, the amount of itaconic acid is at least 50, more desirably at least 70 and preferably at least 80% by weight of the monomers fed to the polymerization.

In one embodiment using metering to incrementally or continuously add co-monomer over a period of at least 30 minutes, the polyols mentioned below may or may not be present during the polymerization. Metering in a co-monomer has shown an effect of accelerating the polymerization of itaconic acid. Metering in co-monomer(s) has been observed to reduce the amount of residual unreacted itaconic acid that exits the polymerization reactor (at the completion of the polymerization) as compared to a polymerization with a single co-monomer(s) addition in the same total co-monomer(s) amount. Metering in co-monomer(s) has been observed to increase the molecular weight of itaconic acid copolymers produced. The co-monomers tend to polymerize preferentially and at a faster rate of incorporation into the polymer than the itaconic acid. A single time addition of co-monomer(s) can temporarily increase the polymerization rate (the speed at which monomers are converted to polymer) but the co-monomer(s) concentration in the continuous phase tends to decrease faster than the itaconic acid concentration because the co-monomers free radically polymerize faster and are incorporated into the copolymer in higher concentration than their concentration in the monomers of the polymerization.

For the purpose of this disclosure, continuously will refer to adding over the specified time even if sometimes the rate of addition is slower than at other times. Incrementally will be defined as in at least two or three increments where each increment can be over a shorter time or a longer time (e.g. semi-continuous). When incremental and a time are specified, the first incremental addition will be considered as occurring at the beginning of the specified time and at least one of the later additions will have to occur at, during, or after the end of the specified time. In one embodiment, the incremental or continuous metering in of the co-monomer(s) occurs over at least one, two or three hours of polymerization. In one embodiment, the metering in of the co-monomers occurs during the time at which the weight ratio of monomer to polymer in the polymerization reactor is less than 1:1, more desirably 0.8:1, more desirably 0.5:1, and preferably 0.2:1 or 0.1:1 as these are the times the monomer concentration in the continuous phase can be the lowest and low monomer concentration further contributes to slow polymerization rates. If co-monomers are present near the end of the polymerization they tend to scavenge up and co-react with the last portion of itaconic acid (decreasing the residual unreacted itaconic acid in the polymerization product). The co-monomer(s) can be added or metered in early during the polymerization as they have a beneficial effect there also. In one embodiment, at least 50 wt. % of the itaconic acid is added initially to the polymerization with the initiator and water (prior to the beginning of the polymerization) and prior to the incremental or continuous addition of co-monomer(s). In one embodiment at least 50 wt. % of the itaconic acid is added as part of said step of adding either incrementally or continuously said co-monomer(s) into said polymerization.

Metered incremental or continuous addition of free radically polymerizable monomers can be utilized for a variety of reasons. As free radical polymerizations are usually quite exothermic and the rate can sometimes be increased by increased reactant temperature, metered incremental or continuous addition of monomer(s) is sometimes used to minimize the monomer concentration in the polymerization media to prevent auto-acceleration of the polymerization. Sometimes, the monomer feed ratio of two monomers drift from the desired ratio due to preferential incorporation of one monomer over the other into the resulting polymer. Metered addition of the faster reacting monomer during the polymerization allows for continuous replacements of the faster consumed monomer (minimizing shifts in the copolymer composition). Metered addition can sometimes be planned to change the ratio of two or more different monomers to result in two compositionally different copolymers in the same reactor. The first copolymer A can be formed when the monomer ratios were “a” and the second copolymer B can be formed when the monomer ratios in the polymerization media were “b”.

Typically, in an itaconic acid polymerization there will be an addition of the continuous media, e.g. water and/or an optional polar organic solvent, itaconic acid (in its acid form, anhydride form, and optionally in its salt form) and a free radical initiator system that functions effectively at the polymerization temperature. Order of addition is not critical and a large portion of the itaconic acid can be charged with the initial loading of the reactor. If the reactants aren't charged at the desired polymerization temperature, the reactants are brought to the desired polymerization temperature. A surfactant or emulsifier can be added to disperse any excess itaconic acid present as droplets, if itaconic acid is present beyond its solubility in the continuous phase. The initiator systems or components thereof can be metered into the reactor if the polymerization time exceeds several half-lives of the initiator system, thereby keeping the active free radical concentration more constant over a longer polymerization time. As taught above, co-monomer(s) can be metered in during any stage of the polymerization. Co-monomers can be included in the initial charge to the reactor. Itaconic acid and co-monomers can be metered in together during the polymerization.

Itaconic acid free radically polymerizes more slowly than acrylic acid so there is some motivation to increase the polymerization rate of itaconic acid so that polymerization time in the reactor can be reduced (allowing more polymerization batches to be produced in a single reactor in any production run). Removing residual non-polymerized itaconic acid from a production run typically involves a procedure to polymerize the itaconic acid or volatilize it from the reaction product.

Itaconic acid has some solubility in water, as reported in The Merck Index, such as 1 g in 12 g of H₂O (8 wt. % itaconic acid in water) or in 5 g of alcohol at room temperature. Some or all of the itaconic acid may be added to the water phase initially during a polymerization or if the amount of itaconic acid desired in the polymerization exceeds its water solubility, a portion of the itaconic acid can be incrementally or continuously metered in as some of the itaconic acid is converted to poly(itaconic acid).

It is often advantageous to also meter in (either continuously or intermittently as defined above) the free radical initiator system or a rate limiting portion of the free radical initiator system. The rate limiting portion of the free radical initiator system is meant to define the portion of the system that is temperature sensitive and/or consumed during the polymerization (often a peroxide or persulfate). Metering in initiator helps maintain a more constant level of free radicals during the polymerization than allowing the concentration of free radical initiator species to decline as the free radical initiator is consumed generating free radicals. The rate of generating free radicals is usually directly proportional to the concentration of the free radical initiator. As itaconic acid polymerizations can proceed at slower rates than acrylic or acrylate polymerizations, it is often desirable to meter in the free radical initiator for at least 30 minutes, more desirably 1, 2, 3, 5 or 8 hours (depending on the rate of polymerization and the total polymerization time for an itaconic acid copolymerization. It is often desirable to dose about 10-60 wt. % of the total free radical initiator early in the polymerization and to meter in over some time period the remaining 40 to 90 wt. % of the initiator.

The polymer may comprise a grafted polymer or copolymer wherein one or more polyols are grafted to the polymer backbone. The polyol may comprise any polyol with a molecular weight of up to about 1000, or in the range from about 50 to about 1000, or from about 50 to about 750, that contains 2 or more hydroxyl groups, or from 2 to about 6 hydroxyl groups, or from 2 to about 4 hydroxyl groups. Examples of the polyols that may be used include ethylene glycol, glycerol, 1,3-propanediol, starch, pentaerythritol, trimethylolpropane, sorbitol, sucrose, xylitolglucose, resorcinol, catechol, pyrogallol, glycollated ureas, 1,4-cyclohexanediol, diethanolamine, triethanolamine, or a mixture of two or more thereof. In one embodiment, it is preferred that at least 50 wt. % of the polyols be glycerol.

The number of structural units derived from itaconic acid, or anhydride or salt thereof, and/or the one or more co-monomers referred to above in the polymer backbone that may be grafted with a polyol may be up to about 30% of the structural units, or from about 1% to about 30%, or from about 1% to about 20% of the structural units may be grafted with a polyol. The number of structural units derived from itaconic acid, or anhydride or salt thereof, in the polymer backbone that may be grafted with a polyol, may be up to about 30% of the structural units, or from about 1% to about 30%, or from about 1% to about 20% of the structural units may be grafted with a polyol.

The number average molecular weight of the polymer acid may be about 5000 or higher, or in the range from about 5000 to about 20,000, or from about 5000 to about 10,000, or from about 7000 to about 9000, or from about 8000 to about 9000.

When the polymer is dissolved or dispersed in water at a concentration of about 50% by weight polymer, the resulting aqueous composition may have a viscosity of up to about 750 centipoise, or in the range from about 50 to about 750 centipoise, or from about 50 to about 600 centipoise, or from about 100 to about 500 centipoise. The viscosities specified above are normally measured using a Brookfield DVII viscometer, #2 spindle, at 100 rpm and at a sample temperature of 25° C. The aqueous composition may comprise a solution or an emulsion.

The polymer may be made by polymerizing itaconic and, optionally, one or more co-monomers using any conventional method such as solution polymerization in water or solvent, emulsion polymerization, reverse emulsion polymerization, suspension polymerization, precipitation polymerization, dispersion polymerization, and the like. The polymerization may be conducted using one or more initiators and/or promoters, as well as one or more of the co-monomers. Initiators, such as sodium persulfate or ammonium persulfate, may be used. Accelerators, such as phosphorus-containing accelerators, may be used. The accelerators that may be used may include sodium hypophosphite, sodium hypophosphite hydrate, and mixtures thereof. The co-monomers may be any of the co-monomers referred to above, including ethyl acrylate, 2-hydroxyethyl acrylate, acrylamide, and the like, as well as mixtures of two or more thereof. In one embodiment it is preferred that the co-monomers include acrylamide alone or acrylamide in combination with at least 2-hydroxyethyl acrylate. The polyol, when grafted on the polymer backbone, may be added to the reaction mixture during polymerization. If the resulting polymerized product has undesirable levels of color, the color may be removed or reduced by adding an effective amount of hydrogen peroxide to the reaction mixture to remove such color or to reduce it to acceptable levels after the polymerization has been completed. The amount of hydrogen peroxide is added to the reaction mixture may be up to about 10% by weight of the reaction mixture, or from about 0.1 to about 10% by weight, or from about 0.1% to about 6% by weight.

The conversion of itaconic acid to polymer may be at least about 85%, or from about 85% to about 99.5%, or from about 94% to about 99%. It was unexpectedly discovered that when polymerizing itaconic acid in the presence of a polyol to form a grafted polymer, the amount of polymer obtained increased by at least about 5%, or from about 5% to about 300%.

An advantage of the invention is that when the itaconic acid, or an anhydride or salt thereof, is polymerized in the presence of a polyol, higher conversions of monomer to polymer may be achieved as compared to when the polyol is not present. This is significant due to the fact that itaconic acid is typically regarded as a monomer that is slow to polymerize. Also, during curing, the polymer crosslinks with the polyol, and, as such, part of the curing may be effected by grafting the polyol on the polymer.

Another advantage of polymerizing itaconic acid, or an anhydride or salt thereof, in the presence of a polyol is that the polymerization process may be simplified due to the fact that additional processing steps of adding the polyol after the polymerization is completed can be avoided. Also, the use of an additional blend tank for mixing the polymer with the polyol can be avoided.

It was unexpectedly discovered that the grafting of the polyol on the polymer backbone could be achieved without gelling. When copolymerizing itaconic acid with more than 15 mole % of the hydroxyalkyl (meth)acrylate, the polymer gels quickly, presumably due to the grafting of the hydroxyl groups during polymerization. With three hydroxyl groups in glycerol, even when used in large amounts, the polymer does not gel when polymerizing the itaconic acid in the presence of the polyol.

The achievement of number average molecular weights in excess of about 5000 for the polymer was unexpected because itaconic acid is a strong chain transfer agent. This usually reduces the molecular weight.

The polymerization of itaconic acid in the presence of a polyol may provide for a polymerization with less than about 10%, or less than about 5% by weight residual itaconic acid monomer. This was unexpected.

The polymer may be dissolved or dispersed in water to form an aqueous binder for fiberglass products, such as fiberglass insulation products, fiberglass filtration products, fiberglass reinforcement mats for construction articles such as duct liners, wallboard composites, pacer sheets, and the like. The aqueous binder may comprise water, and from about 20 to about 70% by weight solids, or from about 25% to about 65%, or from about 30% to about 60%, or from about 40 to about 50% by weight solids. The term “solids” is used herein to refer to the polymer as well as any other ingredient other than water. The concentration of the polymer in the aqueous binder may be in the range from about 20% to about 70% by weight, or from about 25% to about 60% by weight. The aqueous binder may comprise monomeric itaconic acid at a concentration of up to about 15% by weight, or from about 0.5 to about 15% by weight, or from about 0.5 to about 10% by weight, or from about 1 to about 6% by weight. The aqueous binder may contain one or more polyols that are not grafted to the polymer, the concentration of the one or more polyols being up to about 30% by weight, or from about 5% to about 30%, or from about 5 to about 25% by weight, or from about 10 to about 20% by weight. The aqueous binder may further comprise one or more additional ingredients including one or more emulsifiers, pigments, filler, anti-migration aids, curing agents, coalescents, wetting agents, biocides, plasticizers, organosilanes, anti-foaming agents, colorants, waxes, anti-oxidants, and the like, or a mixture of two or more thereof. The concentration of each of these additional ingredients may be up to about 10% by weight. The aqueous binder may be characterized by the absence of formaldehyde.

The aqueous binder may be prepared by dissolving or dispersing the polymer and any of the other desired ingredients in water using conventional mixing techniques. It was unexpectedly discovered that when the polymer is grafted with a polyol, the aqueous binder exhibits a lower viscosity as compared to when using a non-grafted polymer. This advantage may be used to allow for providing aqueous binders that are more concentrated (that is, containing less water) and as a result less costly to ship.

The aqueous binder may be applied to a fiberglass substrate, such as a nonwoven fiberglass substrate, by conventional techniques such as air or airless spraying, padding, saturating, roll coating, curtain coating, beater deposition, coagulation, and the like. The aqueous binder may be applied to a fiberglass mat formed on a paper machine or via a wet-laid process. The aqueous binder may be sprayed, saturated, or coated onto fiberglass used for applications such as insulation products, filtration products, reinforcement mats for construction articles, and the like.

The aqueous binder, after it is applied to fiberglass, may be heated to effect drying and curing. The duration and temperature of heating will affect the rate of drying, processability and handleability, and property development of the treated substrate. Heat treatment at about 120° C. to about 400° C., or at about 150° C., to about 220° C., for a period of time in the range from about 3 seconds to about 15 minutes may be carried out. The drying and curing functions may be affected in two or more distinct steps, if desired. For example, the aqueous binder, after being applied, may be first heated at a temperature and for a time sufficient to substantially dry but not to substantially cure the binder composition, and then heated for a second time at a higher temperature and/or for a longer period of time to effect curing. This procedure, which may be referred to as “B-staging”, may be used to provide binder-treated nonwoven fiberglass, for example, in roll form, which may, at a later stage, be cured, with or without forming or molding into a particular configuration, concurrent with the curing process.

Fiberglass products may be prepared using conventional techniques. For example, a porous mat of fibrous glass may be produced by fiberizing molten glass and immediately forming a fibrous glass mat on a moving conveyor. The aqueous binder may then be applied to the mat to form a treated mat. The treated mat may then be conveyed through a curing oven wherein heated air is passed through the mat to cure the polymer resin. The mat may be slightly compressed to give the finished product a predetermined thickness and surface finish. The curing oven may be operated at a temperature in the range from about 120° C. to about 400° C., or from about 150° C. to about 220° C. The mat may reside within the oven for a period of time in the range from about 3 seconds to about 15 minutes. A fibrous glass, with a cured, rigid binder matrix, may emerge from the oven in the form of a batt which may be compressed for packaging and shipping and which may thereafter recover its vertical dimension when unconstrained.

The fiberglass products may be used for applications such as, for example, insulation batts or rolls, as reinforcing or insulation mat for roofing or flooring applications, as roving, as microglass-based substrates for printed circuit boards or battery separators, as filter stock, as tape stock, as tack board for office partitions, in duct liners or duct board, wallboard composites, pacer sheets, reinforcement scrim for cementitious and non-cementitious coatings for masonry, and the like.

### Example 1

In a 2-liter reactor, the following ingredients are added: 260 g itaconic acid, 136.6 g glycerol, 330 g water and 4 g sodium persulfate. After purging with nitrogen for 20 minutes, the reaction mixture is heated to 75° C. under nitrogen over a period of 40 minutes. After 20 minutes at 75° C., the addition of an initiator in the form of a solution of 8 g sodium persulfate in 40 g water is commenced, the initiator being metered into the reactor over a period of 4 hours. After another 10 minutes, the addition of a premix of 9 g ethyl acrylate, 20.9 g 2-hydroxyethyl acrylate, 27.3 g of a 52% by weight acrylamide aqueous solution, and 15 g water is commenced and the premix is metered into the reactor over a period of 2 hours. The reaction temperature is raised to 78° C. after the initiator is metered into the reactor and maintained at that level for 75 minutes. The reaction mixture is cooled in air to 60° C. When the 60° C. temperature is reached, a redox system of (1) 1.25 g sodium persulfate in 8 g water, and (2) 1.25 g of Bruggolite® FF6 (a product of Bruggeman Chemical identified as a derivative of sulfinic acid) in 20 g water, is added in sequence. The temperature is reduced to below 30° C. A solution of 28% by weight ammonium hydroxide is added to raise the pH to 3.3. The reaction mixture is stirred for 30 minutes. 13.5 g of a 50% hydrogen peroxide solution is added to remove color. Post reaction analysis indicates a residual monomer concentration of 1.6% by mole from proton NMR spectrum, and a calibrated absolute number average molecular weight for the polymer of 8140 using gel permeation chromatography with light scattering detector.

### Example 2

In a 55 liter reactor, the following ingredients are added: 25.42 pounds (11.53 kg) itaconic acid, 13.36 pounds (6.06 kg) glycerol, 0.39 pound (0.18 kg) sodium persulfate and 34.79 pounds (15.8 kg) of water. After purging with nitrogen for 20 minutes, the reaction mixture is heated to 75° C. under nitrogen over a period of 40 minutes. After 20 minutes at 75° C., the addition of an initiator in the form of a solution of 0.78 pound (0.354 kg) sodium persulfate in 3.91 pounds (1.77 kg) water is commenced and the initiator is metered into the reactor over a period of 4 hours. After another 10 minutes, the addition of a premix of 0.88 pound (0.399 kg) ethyl acrylate, 2.04 pounds (0.925 kg) 2-hydroxyethyl acrylate, and 2.67 pounds (1.121 kg) of a 52% by weight acrylamide aqueous solution is commenced and the premix is metered into the reactor over a period of 2 hours. The reaction temperature is raised to 78° C. after the addition of the initiator is completed and the temperature is maintained at that level for 75 minutes. The reaction mixture is cooled in air to 60° C. When the 60° C. temperature is reached, a redox system of 0.12 pound (0.054 kg) sodium persulfate in 1.96 pounds (0.481) water is added, followed by 0.12 pound (0.054) of Bruggolite® FF6 in 1.96 pounds (0.899 kg) water. The temperature is reduced to 30° C. 1.43 pounds (0.649 kg) of concentrated ammonium hydroxide is added to raise the pH to 3.3, followed by 1.89 pounds (0.857 kg) of 35% hydrogen peroxide solution to remove color. Post reaction analysis indicates 98.4% conversion of itaconic acid and non-detectable levels of ethyl acrylate. The viscosity is 393 centipoise. A calibrated absolute number average molecular weight for the polymer of 8140 using gel permeation chromatography with light scattering detector is indicated.

### Example 3

In a 500 ml reactor, the following ingredients are added: 130 g itaconic acid, 69.1 g glycerol, 85 g water and 2 g sodium persulfate. After purging with nitrogen for 20 minutes, the reaction mixture is heated to 75° C. under nitrogen over a period of 30 minutes. The addition of an initiator in the form of a solution of 4.5 g sodium persulfate in 20 g water is commenced and the initiator is metered into the reactor over a period of 5 hours. The reaction temperature is raised to 78° C. after addition of the initiator is complete. The temperature is maintained at that level for 90 minutes. The reaction mixture is cooled in air to 60° C. When the 60° C. temperature is reached, a redox system of 0.63 g sodium persulfate in 10 g water and 0.63 g of Bruggolite® FF6 in 10 g water is added in sequence. The reaction mixture is stirred for 1 hour as the temperature is reduced to below 30° C. 69 g of water are added. Post reaction analysis using proton NMR indicates that 93.8% by weight of the itaconic acid is converted to polymer, the polymer containing 14% by weight grafted glycerol.

### Example 4

In a 500 ml reactor, the following ingredients are added: 130 g itaconic acid, 154 g water and 2 g sodium persulfate. After purging with nitrogen for 20 minutes, the reaction mixture is heated to 75° C. under nitrogen over a period of 30 minutes. The addition of an initiator in the form of a solution of 4.5 g sodium persulfate in 20 g water is commenced and the initiator is metered into the reactor over a period of 5 hours. The reaction temperature is raised to 78° C. after the addition of initiator is complete. The temperature is maintained at that level for 90 minutes. The reaction is cooled in air to 60° C. When the 60° C. temperature is reached, a redox system of 0.63 g sodium persulfate in 10 g water and 0.63 g of Bruggolite® FF6 in 10 g water is added in sequence. The reaction mixture is stirred for 1 hour as the temperature is reduced to below 30° C. 69 g of water are added followed by 69.1 g of glycerol. Post reaction analysis using proton NMR indicates that 88.7% by weight of the itaconic acid is converted to polymer. The polymer contains no grafted glycerol.

### Example 5

In a 500 ml reactor, the following ingredients are added: 130 g itaconic acid, 69.1 g glycerol, 85 g water, 5 g sodium hypophosphite, and 2 g sodium persulfate. After purging with nitrogen for 20 minutes, the reaction mixture is heated to 75° C. under nitrogen over a period of 30 minutes. The addition of an initiator in the form of a solution of 4.5 g sodium persulfate in 20 g water is commenced and the initiator is metered into the reactor over a period of 5 hours. The reaction temperature is raised to 78° C. after the addition of initiator is complete. The temperature is maintained at that level for 90 minutes. The reaction is cooled in air to 60° C. When the 60° C. temperature is reached, a redox system of 0.63 g sodium persulfate in 10 g water and 0.63 g of Bruggolite® FF6 in 10 g water is added in sequence. The reaction mixture is stirred for 1 hour as the temperature is reduced to below 30° C. 69 g of water are added. Post reaction analysis using proton NMR indicates that 98.4% by weight of the itaconic acid is converted to polymer. The polymer contains 13.8% by weight grafted glycerol.

### Example 6

In a 500 ml reactor, the following ingredients are added: 130 g itaconic acid, 154 g water, 5 g sodium hypophosphite, and 2 g sodium persulfate. After purging with nitrogen for 20 minutes, the reaction mixture is heated to 75° C. under nitrogen over a period of 30 minutes. The addition of an initiator in the form of a solution of 4.5 g sodium persulfate in 20 g water is commenced and the initiator is metered into the reactor over a period of 5 hours. The reaction temperature is raised to 78° C. after addition of initiator is complete. The temperature is maintained at that level for 90 minutes. The reaction is cooled in air to 60° C. When the 60° C. temperature is reached, a redox system of 0.63 g sodium persulfate in 10 g water and 0.63 g of Bruggolite FF6 in 10 g water is added in sequence. The reaction mixture is stirred for 1 hour as the temperature is reduced to below 30° C. 69 g of water are added. 69.1 g of glycerol are added. Post reaction analysis using proton NMR indicates that 96.6% by weight of the itaconic acid is converted to polymer. The polymer contains no grafted glycerol.

Examples 3 and 5 are conducted using glycerol during the polymerization reaction, while in Examples 4 and 6; glycerol is not added until after the polymerization reaction is completed. In Examples 3 and 5, glycerol is grafted onto the polymer backbone. With Examples 4 and 6, there is no grafting. Example 3 (grafted) shows a higher conversion of itaconic acid to polymer than Example 4 (not-grafted). Similarly, Example 5 (grafted) shows a higher conversion than Example 6 (not-grafted). Placing glycerol in the reactor consistently increases the conversion of itaconic acid to polyitaconic acid, leaving less residual unreacted itaconic acid, which does not help the binder's performance.

### Example 7

In a 500 ml reactor, the following ingredients are added: 130 g itaconic acid, 11.6 g 2-hydroxyethyl acrylate, 46.1 g glycerol, 4.2 g sodium hypophosphite hydrate, 146.4 g water and 1.3 g ammonium persulfate. After purging with nitrogen for 20 minutes, the reaction mixture is heated to 73° C. under nitrogen over a period of 30 minutes. The addition of an initiator in the form of a solution of 3.9 g ammonium persulfate in 20 g water is commenced with the initiator being metered into the reactor over a period of 6 hours. The reaction is continued for 90 minutes. The reaction is cooled in air to 60° C. and 116 g of water are added. The pH is raised to 3.0 by adding concentrated ammonium hydroxide. Post reaction analysis using proton NMR indicates that 95.4% by weight of the itaconic acid is converted to polymer.

### Example 8

In a 2 liter reactor, the following ingredients are added: 390 g itaconic acid, 34.8 g 2-hydroxyethyl acrylate, 41 g of a 52% solution of acrylamide, 138.2 g glycerol, 456 g water and 6 g ammonium persulfate. The reaction mixture is heated to 72° C. under nitrogen while 11.7 g ammonium persulfate in 60 g water is metered in over a period of 5 hours. The reaction mixture is heated for 2 more hours before being cooled down. 400 g water is added. A sample of 350 g of the reaction mixture is mixed with 10.5 g hydrogen peroxide to remove color. The residual itaconic acid level is 4% by weight as determined by proton NMR. The pH is 2.44.

### Example 9

In a 500 ml reactor, the following ingredients are added: 130 g itaconic acid, 13.65 g of 52% by weight aqueous acrylamide solution, 90.6 g of glycerol, 2 g ammonium persulfate, and 200 g water. The reaction mixture is heated to 73° C. over a period of 30 minutes. The addition of an initiator in the form of 4.5 g of ammonium persulfate in 20 g of water is commenced, the initiator being metered in over a period of 5 hours. 10 minutes after the addition of the initiator is commenced, the addition of 4.5 g of ethyl acrylate and 10.44 g of 2-hydroxyethyl acrylate is started. The monomers are metered in over a period of 3.5 hours. The temperature is raised to 75° C. after the addition of the initiator is completed. The temperature is held at 75° C. for 60 minutes, and then cooled to 65° C. A mixture of 0.63 g of Bruggolite® FF6 in 5 g of water is added. The pH is adjusted to 3.0 by adding ammonium hydroxide. Proton NMR analysis indicates that 98% by weight of the itaconic acid is converted to polymer.

### Example 10

In a 500 ml reactor, the following ingredients are added: 130 g itaconic acid, 13.65 g of 52% by weight aqueous acrylamide solution, 2 g ammonium persulfate, and 150 g water. The reaction mixture is heated to 73° C. over a period of 30 minutes. The addition of an initiator in the form of 4.5 g of ammonium persulfate in 20 g of water is commenced and the initiator is metered into the reactor over a period of 5 hours. 10 minutes after the addition of the initiator is commenced, the addition of a mixture of 4.5 g of ethyl acrylate and 10.44 g of 2-hydroxyethyl acrylate is started. The monomers are metered in over a period of 3.5 hours. The temperature is raised to 75° C. after the addition of the initiator is completed. The temperature is held at 75° C. for 60 minutes, and then cooled to 65° C. A mixture of 0.63 g of Bruggolite® FF6 in 5 g of water is added. 90.6 g of glycerol are added. Water is added to provide a solids content of 40% by weight. The pH is adjusted to 3.0 by adding ammonium hydroxide. Proton NMR analysis indicates that 98% by weight of the itaconic acid is converted to polymer.

### Example 11

In a 500 ml reactor, the following ingredients are added: 130 g itaconic acid, 77.65 g glycerol, 4.5 g ethyl acrylate, 10.44 g 2-hydroxyethyl acrylate, 13.65 g of 52% by weight aqueous acrylamide solution, 1 g trimethylolpropane-triacylate, 2 g sodium persulfate, and 200 g water. Under nitrogen, the reaction mixture is heated to 75° C. over a period of 20 minutes. The addition of an initiator in the form of 4.0 g of sodium persulfate in 20 g of water is commenced and the initiator is metered into the reactor over a period of 4 hours. The temperature is raised to 78° C. after the addition of the initiator is completed. The temperature is held at 78° C. for 75 minutes, and then cooled to 60° C. A mixture of 0.63 g sodium persulfate in 3 g of water is added, followed by 0.63 g of Bruggolite® FF6 in 3 g of water. A solution of 20% sodium hydroxide is added to raise the pH to 2.6. The viscosity is 555 centipoise. The level of residual itaconic acid is 4.5% by weight. The number average molecular weight of the polymer is 8810.

### Example 12

In a 500 ml reactor, the following ingredients are added: 130 g itaconic acid, 86.4 g glycerol, and 200 g water. The reaction mixture is heated to 75° C. over a period of 20 minutes. The addition of an initiator in the form of 6 g of sodium persulfate in 30 g of water is commenced and the initiator is metered into the reactor over a period of 5 hours. 10 minutes after the addition of the initiator is commenced, the addition of a mixture of 4.5 g of ethyl acrylate, 10.44 g of 2-hydroxyethyl acrylate, 13.65 g of 52% by weight aqueous acrylamide solution, 2 g polyethyleneglycol diacrylate and 7 g water is started. This mixture is metered in over a period of 2 hours. The temperature is raised to 78° C. after the addition of the initiator is completed. The temperature is held at 78° C. for 60 minutes, and then cooled to 60° C. A mixture of 0.63 g sodium persulfate in 5 g water is added, followed by 0.53 g sodium bisulfate in 5 g of water. The temperature is cooled to 30° C. 2.86 g concentrated ammonia are added to raise the pH to 2.6. 4.64 g of 35% hydrogen peroxide are added to remove color. The residual level of ethyl acrylate is 62 ppm (GPC), and the residual level of itaconic acid monomer is 5.2% by weight using proton NMR.

### Example 13

In a 500 ml reactor, the following ingredients are added: 130 g itaconic acid, 68.3 g glycerol, and 200 g water. The reaction mixture is heated to 75° C. over a period of 20 minutes while stirring under nitrogen. The addition of an initiator in the form of 4 g of sodium persulfate in 20 g of water is commenced, the initiator being metered in over a period of 4 hours. 10 minutes after the addition of the initiator is commenced, the addition of a mixture of 4.5 g of ethyl acrylate, 10.44 g of 2-hydroxyethyl acrylate, 13.65 g of 52% by weight aqueous acrylamide solution is started. This mixture is metered in over a period of 2 hours. The temperature is raised to 78° C. after the addition of the initiator is completed. The temperature is held at 78° C. for 75 minutes, and then cooled to 60° C. A mixture of 0.63 g sodium persulfate in 5 g water is added. The temperature is cooled to 30° C. 18.77 g of 20% NaOH are added to raise the pH to 2.6. 6.8 g of 50% hydrogen peroxide are added to remove color. The residual level of itaconic acid monomer is 2.9% by weight using proton NMR.

Test samples of reinforced fiberglass are prepared. A Walco test device supplied by the Wallace Company of Pasadena, Calif., is used. The device is identified as Padder 2 and employs a single phase DC drive, DE 2R series. The polymer is diluted in demineralized water to form an aqueous binder with a concentration of 9-11% by weight polymer. The fiberglass substrate is a Whatman Glass Microfibre Filter, Grade GF/A. The Walco test device is used to saturate the fiberglass substrate with the aqueous binder and remove excess polymer. The saturated fiberglass substrate is dried and air in an oven at 375° F. (190.6° C.) for 2 minutes. The polymer is calculated to be about 25% by weight add-on (about 20% by weight loss on ignition). Saturated and cured fiberglass test samples are tested for: (1) dry tensile strength; (2) hot wet tensile strength (82° C. for 10 minutes soaking in demineralized water before testing using a sample size of 1×6 inches (2.54×15.24 cm)); (3) hot dry tensile strength (375° F. (190.6° C.) for 1 minute of aging before testing while at 375° F. (190.6° C.) using a sample size of 1×9 inches (2.54×22.86 cm); and (4) plasticizer resistance (room temperature soaking in diisononyl phthalate (DINP)) for 2 minutes using a sample size of 1×6 inches (2.54×15.24 cm). The fiberglass test substrate does not have a machine drive direction (MD) or a cross-direction (CD), but the lengthwise direction is assumed to be a MD and, consequently, one set of tests is used. Binders containing polyitaconic acid are compared to a binder comprising a commercial acrylic latex emulsion that is crosslinked using hexamethoxy melamine. The results are indicated in Tables 1-3.

TABLE 1

| | | | Dry | Hot Wet | Hot Dry | Plasticizer |
|---|---|---|---|---|---|---|
| | Aqueous | Pick Up | Strength | Strength | Strength | Strength |
| Polymer | Binder pH | % | (lbs) | (lbs) | (lbs) | (lbs) |
| Control in | — | 25.1 | 12.0 | 2.94 | 4.80 | 10.4 |
| form of | | | | | | |
| commercial | | | | | | |
| fiberglass | | | | | | |
| binder- | | | | | | |
| acrylic latex | | | | | | |
| emulsion | | | | | | |
| mixed with | | | | | | |
| melamine | | | | | | |
| formaldehyde | | | | | | |
| resin | | | | | | |
| Example 1 | 3.3 | 26.1 | 12.5 | 7.27 | 10.9 | 9.28 |
| Example 2 | 3.3 | 27.6 | 14.2 | 7.90 | 9.44 | 10.8 |

TABLE 2

| | Aqueous | | Dry | Hot Wet | Hot Dry | Plasticizer |
|---|---|---|---|---|---|---|
| | Binder | Pick Up | Strength | Strength | Strength | Strength |
| Polymer | pH | % | (lbs) | (lbs) | (lbs) | (lbs) |
| Control in | — | 25.9 | 9.81 | 2.49 | 4.47 | 7.64 |
| form of | | | | | | |
| commercial | | | | | | |
| fiberglass | | | | | | |
| binder- | | | | | | |
| acrylic latex | | | | | | |
| emulsion | | | | | | |
| mixed with | | | | | | |
| melamine | | | | | | |
| formaldehyde | | | | | | |
| resin | | | | | | |
| Example 7 | 3.6 | 25.9 | 10.7 | 5.09 | 10.2 | 8.49 |
| Example 8 | 2.4 | 26.2 | 9.04 | 4.49 | 7.12 | 7.27 |
| Example 9 | 3.4 | 23.8 | 10.5 | 6.37 | 6.50 | 9.51 |
| Example 10 | 3.0 | 23.5 | 10.1 | 4.10 | 8.07 | 8.45 |

TABLE 3

| | | | Dry | Hot Wet | Hot Dry | Plasticizer |
|---|---|---|---|---|---|---|
| | Aqueous | Pick Up | Strength | Strength | Strength | Strength |
| Polymer | Binder pH | % | (lbs) | (lbs) | (lbs) | (lbs) |
| Control in | — | 25.6 | 11.5 | 2.02 | 5.10 | 8.08 |
| form of | | | | | | |
| commercial | | | | | | |
| fiberglass | | | | | | |
| binder- | | | | | | |
| acrylic latex | | | | | | |
| emulsion | | | | | | |
| mixed with | | | | | | |
| melamine | | | | | | |
| formaldehyde | | | | | | |
| resin | | | | | | |
| Example 2 | 3.3 | 27.4 | 11.9 | 8.33 | 14.6 | 9.82 |
| Example 12 | 2.6 | 27.0 | 12.0 | 7.59 | 11.7 | 8.85 |
| Example 11 | 2.6 | 26.2 | 11.1 | 8.30 | 9.78 | 9.45 |

The foregoing tests show advantageous results for the inventive polymers as compared to the control. The hot/wet tensile strength results are particularly significant and advantageous due to the fact that the fiberglass products produced using the inventive polymers may be used in hot/wet environments. The inventive polymers exhibit significantly improved hot/wet tensile strengths as compared to the control.

Examples where Glycerol is not Used in the Polymerization or the Product.

The following three examples were added to show that the polymerization of itaconic acid with co-monomers could be achieved without glycerol present for certain embodiments where the glycerol or related polyhydric alcohols are not desired in the final product. The inventive Examples 15 and 16 show that the use of a process of metering in co-monomers can achieve high conversion of all the free radically polymerizable monomers to polymer (e.g. low residual monomer levels). In some applications low residual itaconic acid levels is very desirable. In Example 14, the initiator is metered into the polymerization but all of the itaconic acid is added in the initial charge with water and no co-monomer is metered into the reactor.

### Example 14

### Itaconic Acid Homo-Polymerization

In a 500 ml reactor, the following ingredients are added: 130 g itaconic acid, 115 g water and 2 g sodium persulfate. The reaction mixture is heated to 75° C. over a period of 20 minutes while stirring under nitrogen. The addition of an initiator in the form of 4 g of sodium persulfate in 20 g of water is commenced, the initiator being metered into the reactor over a period of 4 hours. The temperature is raised to 78° C. after the addition of the initiator is completed. The temperature is held at 78° C. for 60 minutes, then cooled to ambient temperature. The residual level of itaconic acid monomer is 16.1% by weight using proton NMR.

### Example 15

### Itaconic Acid and Acrylic Acid (9:1) Polymerization

In a 500 ml reactor, the following ingredients are added: 117 g itaconic acid, 115 g water and 2 g sodium persulfate. The reaction mixture is heated to 75° C. over a period of 20 minutes while stirring under nitrogen. 13 g acrylic acid is metered into the reactor over 3 hours. 30 minutes after the metering of acrylic acid starts, an addition of an initiator in the form of 4 g of sodium persulfate in 20 g of water is commenced. The initiator is metered into the reactor over a period of 4 hours. The temperature is raised to 78° C. after the addition of the initiator is completed. The temperature is held at 78° C. for 60 minutes, then cooled to ambient temperature. The residual level of itaconic acid monomer is 6.3% by weight using proton NMR.

### Example 16

### Itaconic Acid and Acrylamide (9:1) Polymerization

In a 500 ml reactor, the following ingredients are added: 117 g itaconic acid, 100 g water and 2 g sodium persulfate. The reaction mixture is heated to 75° C. over a period of 20 minutes while stirring under nitrogen. 25 g 52% acrylamide solution is metered into the reactor over 3 hours. 30 minutes after the metering of acrylamide solution starts, an addition of an initiator in the form of 4 g of sodium persulfate in 20 g of water is commenced and the initiator is metered into the reactor over a period of 4 hours. The temperature is raised to 78° C. after the addition of the initiator is completed. The temperature is held at 78° C. for 60 minutes, then cooled to ambient temperature. The residual level of itaconic acid monomer is <1% by weight using proton NMR.

### Example 17

### Itaconic Acid, Acrylic Acid and HEMA

In a 500 ml reactor, the following ingredients are added: 117 g, 1.8 mole of itaconic acid, 120 g water, and 2 g sodium persulfate (SPS). The reaction is heated to 80° C. under nitrogen atmosphere. After 1 hour at 80° C., a mixture of acrylic acid (7.2 g, 0.1 mole) and HEMA (13 g, 0.1 mole) in 10 g water is metered into the reactor over 2 hours. 30 minutes after the metering starts a stream of 4 g SPS in 12 g water is metered into the reactor over 4 hours. The reaction is allowed to stay at 80° C. for another hour after the addition of the SPS stream is finished. The reaction is cooled to 62° C. and a mixture of 0.6 g SPS in 4 g water and 0.6 g Burgonlit FF-6 in 10 g water is added. The stirring is continued while the reaction is cooled to room temperature. Proton NMR shows that itaconic acid conversion is at 94%.

### Example 18

### Itaconic Acid, Acrylic Acid, and HEMA Phosphate

In a 500 ml reactor, the following ingredients are added: 117 g, 1.8 mole itaconic acid, 120 g water, 4 g sodium hypophosphite monohydrate, and 2 g sodium persulfate (SPS). The reaction is heated to 80° C. under nitrogen atmosphere. After 1 hour at 80° C., a mixture of acrylic acid (10.8 g, 0.15 mole) and PAM-4000 (HEMA phosphate, 10.5 g, 0.05 mole) in 10 g water is metered into the reactor over 2 hours. 30 minutes after the metering starts, a stream of 4 g SPS in 12 g water is metered into the reactor over 4 hours. The reaction is allowed to stay at 80° C. for another hour after the addition of the SPS stream is finished. The reaction is cooled to 62° C. and a mixture of 0.6 g SPS in 4 g water and 0.6 g Burgonlit FF-6 in 10 g water is added. The stirring is continued while the reaction is cooled to room temperature. Proton NMR shows that itaconic acid conversion is >90%.

The itaconic acid copolymers formed from metering in (continuously or incrementally) additional co-monomer(s) are useful as polyacid components in any of the applications where polyacrylic acid is traditionally used, such as dispersants, water treatment chemical, viscosity modifiers, etc.

While the invention has been explained in relation to various embodiments, it is to be understood that various modifications thereof may become apparent to those skilled in the art upon reading this specification. Therefore, it is to be understood that the invention includes all such modifications that may fall within the scope of the appended claims.

1. A polymer, comprising structural units derived from itaconic acid, or an anhydride or salt thereof, the polymer having a number average molecular weight of about 5000 or higher; when dispersed in water at a concentration of about 50% by weight polymer the resulting aqueous composition has a viscosity of about 750 centipoise or less.

2. A process for the aqueous phase polymerization of itaconic acid, including its acid form, anhydride form, and salt form, comprising the steps of:
a) blending free radically polymerizable monomers with a free radical initiator, wherein at least 50 weight % of the free radically polymerizable monomers are itaconic acid,
b) free radically polymerizing said free radically polymerizable monomers into a polymer,
c) including a step, during said step of free radically polymerizing said monomers, of adding either incrementally or continuously over a time period of at least 30 minutes co-monomers selected from the group consisting of acrylic acid, methacrylic acid, acrylamide, N—C₁₋₆-alkyl-substituted-acrylamide, glycine acrylamide, sarcocine acrylamide, acrylonitrile, methanol or ethanol esters of acrylic or methacrylic acid, acrylonitrile, methacrylonitrile, hydroxyethyl acrylate and its phosphate or polyphosphate esters, hydroxyethyl methacrylate and its phosphate or polyphosphate esters, 2-acryamido-2methylpropanesulfonic acid and its alkali salts, styrene sulfonic acid and its alkali salts, maleic acid, maleic anhydride, vinyl alcohol, vinyl acetate and mixtures thereof; wherein said co-monomers are present in concentrations from 1 to less than 50 weight % of the total of the initially added monomers and the monomers incrementally or continuously added over a time period.

3. A process according to claim 2, wherein repeat units from said co-monomers are present from about 5 to about 30% by weight and repeat units from said itaconic acid is at least 70% by weight of the repeat units of said polymer.

4. A process according to claim 2, wherein said step of adding either incrementally or continuously co-monomer(s) over a time period of at least 30 minutes overlaps a time when the ratio of monomers to polymer in said polymerization step is in the weight ratio of 0.5:1.

5. A process according to claim 2, wherein itaconic acid is present in said co-monomer(s) during said step of adding either incrementally or continuously said co-monomer(s) over a time period of at least 30 minutes.

6. A process according to claim 2, wherein said step of adding either incrementally or continuously co-monomer(s) over a time period of at least 30 minutes overlaps when the ratio of monomers to polymer in said polymerization step is in the weight ratio of 0.2:1.

7. A process according to claim 2, wherein said step of adding either incrementally or continuously co-monomer(s) over a time period of at least 30 minutes occurs when the ratio of monomers to polymer in said polymerization step is in the weight ratio of 0.1:1.

8. A process according to claim 2, wherein up to 50% of said itaconic acid can be in the anhydride or salt form.

9. A process according to claim 2, wherein at least 50 wt. % of the itaconic acid is charged into a reactor with said free radical initiator before the polymerization process is started.

10. A process according to claim 9, wherein a portion of said co-monomers are charged into a reactor with said itaconic acid before the polymerization process is started.

11. A process according to claim 5, wherein at least 50 wt. % of the itaconic acid in said polymerization is added as part of said step of adding either incrementally or continuously said co-monomer(s) over a time period of at least 30 minutes.

12. A process according to claim 2, further including a step of metering in additional free radical initiator either incrementally or continuously for a period of at least one hour during said polymerizing step.

13. A process according to claim 12, wherein the initiator added in said further step of metering in additional free radical initiator comprises at least 40 wt. % of the total initiator added initially to said monomers and metered into the polymerization reactor.

14. A process according to claim 2, wherein up to 80 wt. % of the total initiator can be added in one portion; or incrementally or continuously added to the monomers and initiator at the polymerization temperature up to 3 hours prior to said step of adding either incrementally or continuously over a time period of at least 30 minutes co-monomers.

15. A process according to claim 2, wherein at least 50 wt. % of the total initiator is added in one portion, incrementally, or continuously at least 1 hour prior to said step of adding said co-monomers either incrementally or continuously over a time period of at least 30 minutes.

16. A process according to claim 2, wherein 60 to 80 wt. % of the total initiator is added in one portion, incrementally, or continuously at least 2 hours prior to said step of adding said co-monomers either incrementally or continuously over a time period of at least 30 minutes.

17. A process according to claim 2, wherein 60 to 100 wt. % of the total initiator is added in one portion, incrementally, or continuously at least 2 hours prior to said step of adding said co-monomers either incrementally or continuously over a time period of at least 30 minutes.
